(19) United States
(12) Patent Application Publication
(10) Pub. No.: US 2021/0182759 A1
(43) Pub. Date: Jun. 17, 2021

(54) NETWORK COMPUTER SYSTEM FOR MATCHING SERVICE PROVIDERS TO TRANSPORT REQUESTS USING PROVIDER-SELECTED CRITERION

(71) Applicant: Uber Technologies, Inc., San Francisco, CA (US)

(72) Inventors: Eoin O'Mahony, San Francisco, CA (US); Lior Seeman, San Francisco, CA (US); Danhua Guo, San Francisco, CA (US); John Mark Nickels, San Francisco, CA (US); Rachel Maddux, San Francisco, CA (US); Eli Gutin, San Francisco, CA (US); Chong Yang Goh, San Francisco, CA (US); Joanne Smith, San Francisco, CA (US)

(21) Appl. No.: 17/107,564

(22) Filed: Nov. 30, 2020

Related U.S. Application Data
(60) Provisional application No. 62/942,068, filed on Nov. 29, 2019.
(60) Provisional application No. 62/961,508, filed on Jan. 15, 2020.

(51) Int. Cl. G06Q 10/06; G06Q 50/30

(52) U.S. Cl. CPC G06Q 10/06316; G06Q 50/30

(57) ABSTRACT

A network computing system that operates to enable each service provider of a plurality of service providers to select a parametric value that is determinative of a service value for a transport service that is to be provided by the service provider over a given time interval. The network computing system can match service providers to transport requests, based on determination that matched service providers satisfy each of (i) an arrival condition for the transport request of the requester, and (ii) a service value condition that is based at least in part on the selected parametric value of the matched service provider.

### RELATED APPLICATIONS

This application claims benefit of priority to Provisional U.S. Application No. 62/942,068, filed Nov. 29, 2019; and to Provisional U.S. Application No. 62/961,508, filed Jan. 15, 2020; all of the aforementioned priority applications being hereby incorporated by reference in their respective entireties for all purposes.

### TECHNICAL FIELD

Examples pertain to a network computer system for matching service providers to transport requests using provider-selected criterion.

### BACKGROUND

Numerous on-demand services exist to offer users a variety of services: transportation, shipping, food delivery, groceries, pet sitting, mobilized task force and others. Typically, on-demand services leverage resources available through mobile devices, such as wireless (e.g., cellular telephony) devices, which offer developers a platform that can access sensors and other resources available through the mobile device. Many on-demand services include dedicated applications (sometimes referred to as “apps”) to communicate with a network service through which an on-demand service is offered.

A transport matching service is one type of on-demand service, where one class of users request transport services (“requesters,” such as riders), another class of users provide the transport service (“service providers,” such as drivers), and the matching service matches service providers and requesters. Generally, such transport arrangement services require significant network computing resources and infrastructure to operate. Under some conventional approaches, transport matching services implement an information exchange platform for enabling inflows of information and input signals from devices of the user base, from which determinations and output signals are generated and communicated to the devices of the user base. Among other technical requirements, and as the name suggests, a network computing system for providing a transport matching service must be sufficiently robust to instantly handle changes resulting from the user base acting on their preferences, intent and circumstances.

### BRIEF DESCRIPTION OF THE DRAWINGS

FIG. 1 illustrates an example service arrangement system to service providers to transport requests using service provider criterion.

FIG. 2A illustrates an example method for arranging service providers to fulfill transport requests of requesters.

FIG. 2B illustrates another example method for arranging service providers to fulfill transport requests of requesters.

FIG. 3A through FIG. 3D illustrate user interfaces for a service provider device, according to one or more examples.

FIG. 4A and FIG. 4B illustrate user interfaces for a requester device interface, according to one or more examples.

FIG. 4C illustrates a user interface for a requester device, in connection with a requester specifying input to alter or configure a default matching process.

FIG. 5 is a block diagram that illustrates a computer system on which examples described herein may be implemented.

FIG. 6 is a block diagram illustrating an example user device for use with examples as described.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

According to examples, a network computing system operates to match a service provider (e.g., driver) to a transport request based on the service provider satisfying each of an arrival condition and a service value condition for the matched transport request. The satisfaction of the arrival condition may be based on a determination that the service provider can arrive and be available at a service start location (e.g., pickup location) to fulfill a requester's transport request. The satisfaction of the service value condition can be based on a parametric value that is selected by the service provider, where the selected parametric value is a determinative factor of a service value for a transport service that the service provider provides in fulfilling the transport request. In some examples, the matched service provider may thus satisfy a metric that estimates the service value which a requester may incur in connection with the service provider fulfilling a service request of the requester.

Still further, some examples provide for a network computing system that communicates over one or more networks, with (i) a plurality of service provider devices to determine a current location of each service provider device of the plurality of service provider devices, and (ii) a requester device of a requester to receive a transport request, the transport request specifying at least one of a service start location or service end location. The network computing system determines, from the current location of each service provider during a given time interval, a quantitative measure of service providers that are available in a given area to provide transport services. Additionally, the network computing system determines, for the given area and a given time interval, a default parametric value that is based at least in part on the quantitative measure of service providers. Individual service providers that operate in the given area can select a parametric value from multiple possible parametric values, wherein the multiple possible parametric values include the default parametric value. The network computing system arranges transport to fulfill a transport request communicated from the requester device of the requester, in part by matching a service provider to the transport request. The matching may be based on a determination that the matched service provider satisfies each of (i) an arrival condition for the transport request of the requester, the arrival condition being based, at least in part, on a current location of the matched service provider and at least one of the service start location or the service end location; and (ii) a service value condition that is indicative of a service value that can be computed for the matched service provider to fulfill the transport request of the requester. In connection with the network computing system arranging transport to fulfill the transport request, examples further provide for the network computing system to compute the service value based on, for example, the default parametric value, the service start location and the service end location.

In examples, the service value for a transport service provided by a service provider is based on application of the selected parametric value of the service provider to a baseline value. Through selection of the parametric value, the service provider can set the service value for transport services that the service provider provides to be greater than, less than, or equal to the baseline value.

In some examples, the baseline value can be based on metrics such as a distance and/or time of travel, and the selected parametric value of individual service providers can correspond to a provider-selected multiplier (e.g., 1.1 or 2.5). In such examples, the service value associated with a service provider fulfilling a transport request may be based on a product of the baseline value and the selected parametric value of the service provider. As another example, the selected parametric value of individual service providers can include or correspond to a differential amount which can be added or subtracted from a baseline value.

According to examples, the network computing system can calculate a default parametric value that reflects a comparison as between a measure of requesters and a measure of service providers. The default parametric value can be computed or calculated periodically or at specified instances of time. The default parametric value may be specific for a given geographic subregion or area and for a current time interval (the time interval when the computation occurs) or an upcoming time interval (a time interval in the future). The measure of the number of requesters may reflect a number of requesters with open transport requests, and/or requesters which are expected to be present, in the given geographic region or area for a current or upcoming time interval. Likewise, the measure of service providers may reflect a number of service providers that are currently available and/or expected to be available in the geographic subregion or area in a current or upcoming time interval. Thus, for a given subregion or area, when a measure of service providers in a first time interval exceeds that of a second time interval, the default parametric value for the given subregion or area may be higher in the first time interval than in the second time interval. Additionally, the default parametric value can be dynamic, so as to change based on time and/or location.

In examples, the default parametric value can service as a guide for service providers, to facilitate service providers in selecting their respective parametric values. In some examples, the default parametric value provides an optional basis for calculating a service value for a transport service provided by a service provider. The default parametric value can represent an optimal setting for service providers, representing an estimated measure of the highest service value which the service provider can receive without detrimentally impacting the likelihood that the service provider can be matched to a transport request. To guide service providers, examples further provide that the default parametric value can be published or otherwise made available to service providers, to enable service providers to manually adjust or update their selected parametric value.

In some examples, the network computing system can enable service providers to provide input to automatically set the selected parametric value to be the same as the default parametric value. As an addition or variation, the network computing system can enable service providers to provide input to automatically set the selected parametric value to be a greater of the default parametric value or an alternative parametric value specified by the user.

According to examples, the network computing system can implement a matching process in which the selected parametric value of a matched service provider is one of (i) a lowest selected parametric value amongst service providers that satisfy the arrival condition, or (ii) equal to the default parametric value.

According to some examples, a network computing system can operate to enable each service provider of a plurality of service providers to select a parametric value that is determinative of a service value for a transport service that is to be provided by the service provider over a given time interval. The network computing system monitors a location of each service provider of the plurality of service providers. In response to receiving a transport request for a transport service from a requester device of a requester, the network computing system matches a service provider of the plurality of service providers to the transport request, based on a determination that the matched service provider satisfies each of (i) an arrival condition for the transport request of the requester, and (ii) a service value condition that is indicative of a computed service value that will be charged to the requester for the transport service provided by the service provider, where the computed service value being based, at least in part, on the selected parametric value of the matched service provider.

In examples, a network computing system sends an invitation message to one or both of the requester device and a provider device of the matched service provider. Depending on implementation, the network computing system can send the invitation message to each of the requester device and the provider device of the matched service provider concurrently or at different times. In some instances, the network computing system can send an invitation message to the provider device first to allow for the matched service provider to accept the match (i.e., agree to provide the service for the requester) and only if the provider device accepts, subsequently send an invitation message to the requester device. Alternatively, the network computing system can reverse the above sequence of messaging such that the requester device receives an invitation message first and choose to accept or reject the match. The invitation message to the requester device may identify the matched service provider, and the invitation message to the matched service provider device may identify the requester and may also provide information about the transport request. Upon the requester and the matched service provider accepting the respective invitation messages, the network computing system can monitor the transport service provided by the matched service requester until completion. The network computing system can determine, from monitoring the transport service, at least one of a distance or a time of travel for the matched service provider in providing the transport service. The network computing system can further determine a baseline value for the transport service based, at least in part, on a base rate, where the base rate being dependent on at least one of the determined distance or time of travel. In examples, the network computing system can determine a service value for the transport service based on the baseline value and the selected parametric value.

Among other benefits, examples as described include a network computing system to implement a transport matching service that minimizes the occurrence of cancellations, which can occur by actions of either requester or service provider. Under conventional approaches, one typical reason behind service provider cancellations is that the service provider deems an assigned transport request as not providing sufficient compensation, such as in the case when the service provider has to travel an extended distance to provide a relatively short trip to a requester. A transport matching service can accommodate and provide for the possibility of cancellations, typically through performance of additional operations, often at the inconvenience of the other party in the matching. For example, in the case when a service provider cancels on a matched transport request, the network computing system may have to perform additional steps of (i) notifying the requester of the cancellation, (ii) finding a new match for the requester, (iii) communicating information about the new match to the requester, and (iv) recalculating estimated service provider transport times (e.g., to pickup location or destination). The inconvenience caused by a cancellation can also deter future instances of the requester using the transport matching service.

To overcome such shortcomings, examples provide a transport matching service that includes functionality for enabling matchings to be performed which automatically and dynamically accommodate the compensation requirements of service providers. Moreover, an example transport matching service, as described, enables a matched service provider and requester to receive information about their pairing in advance of the service provider and requester having the opportunity to accept or decline the pairing or matching with no penalty. By enabling the service provider and/or requester to decline the matched pairing, an example transport matching service as described can avoid circumstances that are more prevalent with conventional transport matching services, where, for example, either the requester or service provider cancels after the transport matching service as made a commitment to the respective parties. Through implementation of a matching process and workflow as described by various examples, examples provide for a transport matching service that is able to avoid system-level inefficiencies which would otherwise occur as a result of the user-driven nature of the transport matching service.

As used herein, a client device, a computing device, and/or a mobile computing device refer to devices corresponding to desktop computers, cellular devices or smartphones, laptop computers, tablet devices, etc., that can provide network connectivity and processing resources for communicating with a service arrangement system over one or more networks. In another example, a computing device can correspond to an in-vehicle computing device, such as an on-board computer. Also, as described herein, a user can correspond to a requester of a network service (e.g., a rider) or a service provider (e.g., a driver of a vehicle) that provides location-based services for requesters.

Still further, examples described relate to a variety of location-based (and/or on-demand) services, such as a transport service, a food truck service, a delivery service, an entertainment service, etc., to be arranged between requesters and service providers. In other examples, the system can be implemented by any entity that provides goods or services for purchase through the use of computing devices and network(s). For the purpose of simplicity, in examples described, the service arrangement system can correspond to a transport arrangement system that arranges transport and/or delivery services to be provided for riders by drivers of vehicles who operate service applications on respective computing devices.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

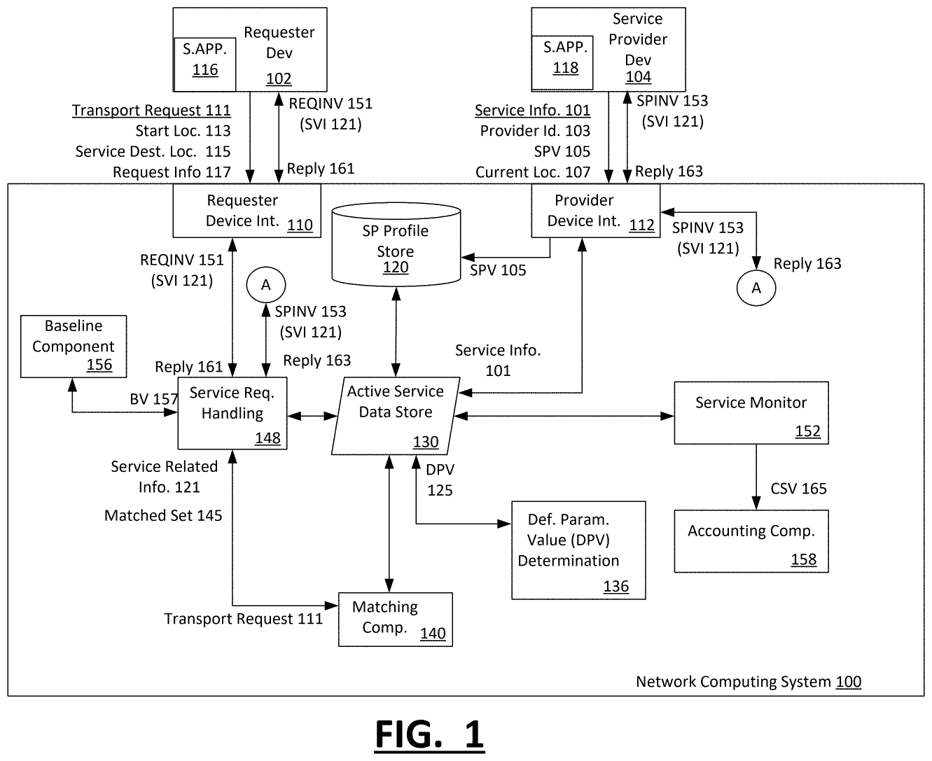

FIG. 1 illustrates an example of a network computing system for matching service providers with transport requests, in accordance with one or more embodiments. In some examples, a network computing system 100, as illustrated with FIG. 1, enables a network platform in which users operate mobile computing devices that provide functionality to facilitate the user's participation and use of a matching service. In examples, the users of the network computing system 100 include service providers (e.g., drivers who operate their own vehicles to transport riders) and requesters (e.g., riders who request and receive transport services from drivers). The transport service provided by the service provider may include a service in which the service provider operates a vehicle to transport the requester from a service start location (e.g., pickup location) to a service end location (e.g., destination or drop-off location). In variations, examples described with the network computing system 100 can be applied to other types of transport services, such as, for example, group transport (e.g., rider has friends or family who accompany the rider on the trip), pooled transport (e.g., driver picks up additional riders who separately request the transport service, typically with different pickup locations and/or drop-off locations), bus transport (e.g., driver transports multiple riders in large-capacity vehicle, sometimes while following a pre-determined route), or delivery transport (e.g., service provider picks up and delivers an item).

With reference to FIG. 1, the network computing system 100 includes, a requester device interface 110, a provider device interface 112, an active service data store 130 and a matching engine 140. The provider device interface 112 includes or performs processes that run on the network-side of the network computing system 100 to establish communication channels with individual devices of service providers. For example, the device interface 112 can establish secure sockets with different types of mobile devices, which service providers of the network computing system 100 can utilize when providing services using their respective vehicles.

In some examples, the service providers operate mobile devices (represented in FIG. 1 by the provider device 104) on which a corresponding service application 118 is executed. Among other functionality, the service application 118 can execute to automate operations which include indicating the availability of the respective service provider to provide service, communicating location information to enable the network computing system 100 to monitor the location of the service provider's vehicle, receiving information from the network computing system 100 for facilitating the service provider in receiving and fulfilling matched transport requests, and communicate information to the network computing system 100 for various purposes, including provisioning determination. Additionally, the service application 118 can execute to generate messages and provide interactive features to enable the service provider to provide input.

The requester device interface 110 includes or performs processes that run on the network-side of the network computing system 100 to establish communication channels with individual devices of requesters. The requesters may also operate mobile devices (represented in FIG. 1 by the requester device 102) on which a corresponding service application 116 runs. The requesters may operate respective service applications 116 to request transport-related services, such as human transport between a service start location 113 (or pickup location) and a service-end location 115 (or drop-off/destination). In variations, the types of services which may be arranged through the network computing system 100 may include human transport, deliveries, shipping, and delivery of on-demand services (e.g., food trucks). As another variation, the types of services which may be arranged through the network computing system 100 may include pickup and delivery services, such as for pickup and delivery of food from restaurants.

According to some examples, the provider device 104 initiates communications with the network computing system 100 using the service application 118. The service application 118 may correspond to a program (e.g., a set of instructions or code) that is downloaded and stored on the requester device 102 of the service provider. The service provider can launch the service application 118 in order to access and utilize a matching service provided by network computing system 100. Through use of the service application 118, the service provider can receive transport requests, and the service provider may operate a service vehicle to fulfill matched transport requests. Once the communication channel is established, the provider device 104 can automatically communicate service information 101 to the network computing system 100, at repeated intervals or continuously. The service information 101 may include the provider's identifier 103, and the provider's current location 107, which may be determined by the service application 118 interfacing with a satellite receiver (e.g., GPS component or other location-aware resource) of the provider device 104.

In some examples, the service information 101 can also include a parametric value 105 which the service provider has selected. The selected parametric value 105 can correspond to, for example, a multiplier or surcharge value which can be combined with a baseline value to determine a service value that is charged to a requester for receiving a transport service from the service provider. The service provider can interact with the service application 118 executing on the provider device 104 to specify the selected parametric value 105. The network computing system 100 can allow for the provider to specify the selected parametric value 105 as a fixed value, meaning the selected parametric value 105 does not change for the service provider unless the change is made by the service provider. As an addition or variation, the network computing system 100 can allow for the provider to specify the selected parametric value 105 as being a dynamic value that is determined by the network computing system 100 by default (“default parametric value 125”). As described in more detail, the network computing system 100 can determine the default parametric value 125 to correlate to a comparison of a measure of service providers to a measure of requesters, for a particular subregion or area where transport service may be initiated, and for a current or upcoming time interval.

The network computing system 100 can also maintain a service provider profile store 120, which can identify, for example, preferences, settings, historical activity and other information about individual service providers. While some examples provide for the selected parametric value 105 of the service provider to be communicated from the service provider device 104, in variations, the network computing system 100 can store the selected parametric value 105 of individual service providers. For example, the service profile data store 120 can store the selected parametric value 105 for individual service providers. When a service provider interacts with the service application 118 to change his or her selected parametric value, the updated parametric value can be updated as stored in the service profile data store 120.

As another addition or variation, the service provider can specify the selected parametric value 105 to be a range value set that includes a fixed floor value and the default parametric value 125. As a range value set, the selected parametric value 105 can reflect, for example, the higher of the fixed value or the default parametric value 125 for a matched transport request.

Still further, in some examples, service providers can selected multiple parametric values 105, and the determination of which selected parametric value 105 is active for a service provider may be based on service parameters of the transport request. For example, individual service providers may be able to specify a first selected parametric value 105 in connection with transport requests which specify a first type of transport service (e.g., regular transport), and a second parametric value 105 in connection with transport requests which specify a second type of transport service (e.g., luxury transport). Thus, service providers who operate, for example, dual-service vehicles can utilize alternative selected parametric values 105, in order to be matched to a greater number of transport requests. Similarly, some examples may enable service providers to select multiple parametric values 105 in connection with other attributes of a matched transport request, such as distance or duration of the transport request. For example, some service providers can specify a first selected parametric value 105 for transport requests which are for trips that are more than a given threshold distance or duration, and a second selected parametric value 105 for transport requests which are for trips that are less than a given threshold distance or duration.

In examples in which a service provider has multiple active concurrent parametric values 105 (e.g., such as for providing different types of transport requests, or providing transport of different durations/distances), the service provider can similarly fixed or dynamic values for each selected parametric value 105. For example, the service provider can specify (i) a first parametric value to be dynamic, ranging between a lesser floor value and the default parametric value 125, and (ii) a second parametric value that is dynamic and ranges between a higher floor value and the default parametric value. Still further, the service provider can select one or both of the parametric values 105 to be fixed at respective lower and higher values, or one of the selected parametric values 105 to be fixed and the other dynamic.

The active service data store 130 maintains the most recent service information 101 (e.g., current location 107) for each active service provider at a particular moment. By way of example, each service provider may start a shift by operating the service application 118 (e.g., opening the application on the provider's device 104), and then toggling a state feature provided by the service application 118 to ‘on duty’. The service application 118 communicates the activation of the state feature to the network computing system 100 via the provider device interface 112. The provider device interface 112 processes the service information 101 received from individual service providers. For each service provider, the provider device interface 112 extracts the service provider identifier 103 and the current location 107 of the service provider device 104. As the service provider's location (e.g., with movement of the service provider's vehicle) and availability changes, subsequent communications from the provider device 104 via the provider device interface 112 can be used to update the active service data store 130. In this way, the active service data store 130 may reflect the most current location of each service provider. In some examples, the provider device interface 112 also extracts the selected parametric value 105 which can be confirmed or updated by the service provider through an interactive user interface of the service application 118.

In examples, a service monitor component 152 accesses information maintained with the active service data store 130 to monitor activities of service providers and/or requesters. The active service data store 130 may also associate a service state with each service provider. Initially, when the service provider goes on duty, the service state of the service provider is available, meaning the service provider can be matched to a transport request. Once the service provider is matched to a transport request, the associated state of the service provider may change, to reflect, for example, one more unavailable states (e.g., on-trip, on route to service start, etc.). Likewise, when the service provider fulfills a transport request, the service provider's service state may change once again to reflect the available state. In this way, the service state and location of each service provider can be tracked or otherwise monitored as the service provider operates a service vehicle in a given geographic region, and for example, as the service provider enters a predefined geographic subregion (or “geofenced subregion”).

In variations, the service state of the service provider can include additional designations where the service provider may be deemed available for matching to new transport requests. As an example, the service state of the service provider can designate a state where the service provider is nearing completion of an existing transport request. In such examples, the service provider may be deemed available in an upcoming time interval, where the service provider will be at the drop-off location of the transport request which the service provider is currently fulfilling. As another example, once a service provider accepts a transport request, the service state of the provider may be changed from available to a designation that reflects the service provider has been initially matched. The initial match designation may be maintained for a threshold time interval (e.g., ten seconds, one minute), after which the service provider's designation may reflect an unavailable state (e.g., while the service provider is on route to pickup the requester, or on-trip to transport the transport requester). In such examples, the service provider may be deemed available for matching with other transport requests if the matching is deemed preferable for the service provider, requester and/or in furtherance of a system objective (e.g., reduce wait-time for multiple requesters).

In some examples, the requester device interface 110 and provider device interface 112 each include or use an application programming interface (API), such as an externally provider-facing API, to communicate data with the requester and provider devices 102, 104, respectively. By providing the externally facing API, the network computing system 100 can establish secure communication channels via secure access channels over the network through any number of methods, such as web-based forms, programmatic access via RESTful APIs, Simple Object Access Protocol (SOAP), remote procedure call (RPC), scripting access, etc.

The requester device interface 110 can communicate with the requester device 102 to receive or process transport requests 111 and requester information 117. When, for example, a requester opens the service application 116 on the requester device 102, the service application 116 may cause the requester device 102 to transmit requester information 117 to the network computing system 100, where the requester information 117 includes the requester identifier and the current location of the requester. Subsequently, while the service application 116 is operating on the requester device 102, the service application 116 can execute to repeatedly and automatically transmit the current location of the requester to the network computing system 100. The requester device interface 110 can receive and record the requester information as part of the active service data store 130. For example, the active service data store 130 create or update a requester record to reflect the requester has the service application 116 open, along with the current (or recent) location of the requester.

According to examples, the requester may initiate a transport request 111 from the requester device using the service application 116, where the transport request 111 specifies a set of transport request parameters, such as a service start location 113 (e.g., pickup location of requester or restaurant), and a service end location 115 (e.g., destination of requester's transport, location of requester receiving food delivery). Each transport request may also be associated with requester information 117, such as the requester identifier and the current location of the requester.

In examples, the service monitor component 152 can also monitor activities of the requesters via data that is maintained with the active service data store 130. For example, when the requester initially opens the service application 116, the service monitor component 152 may associate the requester with a designation of being a source for a potential transport request, as well as a current location of the requester. When the requester initiates a transport request, the service monitor component 152 can update the requester record to reflect an open and unassigned transport request. Similarly, when the requester is assigned to a service provider, the requester record can be linked to the service provider, to reflect the requester as awaiting or receiving transport.

In examples, the network computing system 100 includes a default parametric value determination component (“DPVDC 136”) to repeatedly determine the default parametric value 125 at multiple locations (or areas) of a geographic region. For example, a geographic region can be pre-divided into subregions, and the DPVDC 136 can determine the default parametric value 125 to be specific to a particular subregion and a particular time interval when the determination is made. In variations, the DPVDC 136 can determine the default parametric value 125 for individual transport requests or other requester-generated events, based on, for example, the current or expected location of the requester and/or the service start location of a transport request. In variations, the DPVDC 136 can determine multiple default parametric values 125 for a given area over a given time interval. The DPVDC 136 can, for example, determine alternative default parametric values 125 for different types of transport services. For example, the DPVDC 136 can determine a first default parametric value 125 for a regular transport service, and a second default parametric value 125 for a luxury transport service.

In examples, the DPVDC 136 determines a quantitative measure of service providers that are available in a given area to provide transport services. The DPVDC 136 can make the determination based on information retrieved from the active service data store 130. The retrieved information can identify, for example, a number of active requesters and service providers that are active, present or near a given region. The information retrieved by the DPVDC 136 can identify, for example, location- or sub-region-specific information for an upcoming time interval, including a measure of requesters as compared to a measure of available service providers. The measure of requesters can include (i) a number of requesters within the subregion or location that have open transport requests; (ii) a number of potential requesters within the location or subregion, which may correspond to a number of users who have opened the service application 116 on a respective requester device 102; and/or (iii) historical information about the presence of requesters in the subregion or area, such as historical information reflecting a number of requesters in one or more prior and relevant times. In variations, the measure of the number of requesters can be based on other information, such as event information (e.g., location where public event is about to occur or end, resulting in a flood of requesters). Based on implementation, the measure of requesters can be based on actual requesters, probable requesters and/or forecasts for requesters. Similarly, the measure of service providers can include (i) a number of service providers that are located within a subregion or area; (ii) a measure of service providers which can likely travel to the subregion or area by traveling a duration or distance that is less a predetermined threshold (e.g., service providers that are ‘nearby’); (iii) historical information about the presence of service providers in the subregion or area, such as information that indicates a likelihood of a number of service providers going online (or conversely offline) in the subregion or area during a relevant time interval.

The DPVDC 136 can determine the default parametric value 125 based at least in part on the quantitative measure of service providers. The quantitative measure can correspond to, for example, a comparative metric, such as a ratio of the measure of requesters over the measure of service providers. In variations, the DPVDC 136 can determine the comparative metric as a difference between the measure of requesters and the measure of service providers.

Additionally, in examples, the DPVDC 136 can determine the default parametric value 125 based on an average (including weighted average), median or other combination of the selected parametric value 105 of other service providers that are within a threshold travel distance or predefined area. Thus, for example, if the selected parametric value 105 of a majority of the service providers is higher than the default parametric value 125 which would otherwise be indicated by comparing the measures of requesters and service providers, the DPVDC 136 can raise the default parametric value 125 to reflect the higher fixed values of some of the available service providers. Still further, in other variations, the DPVDC 136 can determine the default parametric value 125 to be based on the selected parametric value 105 of service providers that are located within a subregion or within a threshold distance of one another. In examples, the DPVDC 136 repeatedly updates the default parametric value 125 at multiple subregions, areas or locations of a geographic region, and the updated default parametric value 125 can be linked or otherwise associated with available service providers.

In examples, the default parametric value 125 can be determined as an area specific value. For example, the default parametric value 125 can be determined for a predetermined geofenced area (e.g., predefined city block or airport region). Additionally, the default parametric value 125 can be determined repeatedly for discrete time intervals (e.g., every 5-10 seconds). The network computing system 100 can communicate or otherwise make the default parametric value 125 of a given area available to service providers who are located in that region during the time interval when the determination is made. For example, the DPVDC 136 can determine the default parametric value 125 for multiple predefined areas. The DPVDC 136 can access service provider records of, for example, the service provider profile store 120 to identify service providers who are currently located in one of the predefined areas, and for each predefined area, the DPVDC 136 can record the default parametric value 125 with the records of the service providers who are located in that predefined area during the current time interval. For individual service providers, some examples provide for the provider device interface 112 to periodically (e.g., every 5 seconds) access the active service data store 130 to read the default parametric value 125 that is associated with that driver's record, and to transmit or otherwise make the default parametric value 125 available to the service provider device 104. In this way, the default parametric value 125 for a predetermined area can be repeatedly communicated to drivers who are available or who operate in that area.

Still further, in some variations, a communication component or process can communicate the default parametric value to service providers. For example, a notification component can notify service providers of updated default parametric values 125 based on the respective location of the service providers. As an addition or alternative, the communication component or process can publish one or more default parametric values on a map of a region which includes one or more areas which are associated with default parametric values 125. Service providers can respond to such notifications by, for example, providing input to update their respective selected parametric value 105 with the service profile data store 120.

The matching engine 140 can be triggered to respond to different activities of a given requester to generate service value information 121 and/or service provider matching results for requesters. With reference to an example of FIG. 1, a request handling component 148 can include processes that detect different user activities, and to trigger the matching engine 140 to generate service value information 121 and/or matching results, based on the detected type of requester activity.

In some examples, the matching engine 140 can generate service provider matching results 145 as part of a matching process, and the request handling component 148 can implement a workflow that results in a service provider being assigned to a transport request (or requester). The matching engine 140 can also generate service value information 121 as a response to certain types of user activity, where the service value information 121 reflects an expected result of a matching process. In examples, the service value information 121 can correspond to a service value, or range of service value, which may be charged to a requester for fulfilment of the requester's transport request.

In some implementations, the matching engine 140 processes simulated transport requests to determine expected service value information 121 for possible or likely transport requests of the requester. The matching engine 140 can determine the expected service value information 121 for a simulated transport request by i) determining the default parametric value 125 for a location of the simulated transport request, and ii) applying the default parametric value 125 to a baseline value for fulfilling the simulated transport request (e.g., where the baseline value is based on an expected duration and/or distance of travel for a trip between the expected service start and end locations 113, 115). Accordingly, in determining the expected service value information 121, some examples provide for the matching engine 140 to apply the default parametric value 125 to a determined baseline value, where the baseline value takes into account the service start and end locations 113, 115. In variations, the matching engine 140 can determine the service value information 121 by selecting one or more service providers for the simulated request, and by applying the selected parametric value 105 of the selected service providers to the base rate value to determine the service value information 121.

In some examples, the matching engine 140 can generate expected service value information 121 as a response to requester activity that is indicative of an expected user transport request in an upcoming or future time interval. The user activity can correspond to the requester opening the service application 116 on the requester device, or the requester interacting with the service application 116 after a period of inactivity. In response to activity that is indicative of a future or expected transport request, the request handling component 148 can generate transport request 111 as a simulation, based on, for example, a set of request parameters that are determined from the user's current location and/or profile information (e.g., historical information about a requester's recent requests, preferences of the user, etc.). The request handling component 148 can communicate the simulated transport request 111 to the matching engine 140, to obtain expected service value information 121, such as an expected service value charge (or range thereof) for a transport request that the user has yet to confirm or make. To illustrate an example, the user activity can correspond to the user opening the service application 116 on the requester device 102, the request handling component 148 triggering the matching engine 140 to generate the expected service value information 121, which the request handling component 148 returns as output for the service application 116 to render to the requester. In this way, the user can view, for example, an expected service value charge for transporting the user from the user's current or planned location to a favorite or recent location of the user.

In some examples, the requester activity can correspond to the user making an affirmative transport request, such as by providing input that specifies or confirms a set of service parameters (e.g., service start location 113, service end location 115) for a transport request 111. For example, the requester may interact with the service application 116 to generate a transport request 111 that includes service start and end locations 113, 115. The service start location 113 can, for example, be automatically determined based on the current location of the requester (e.g., as determined through a satellite receiver or other location-aware resource of the requester). The service end location 115 can be automatically determined by, for example, the requester's profile information (e.g., requester favorite location, user's recent destinations, popular destinations for the user's current location, etc.). Alternatively, the service start and/or end locations 113, 115 can be specified by requester input, provided through interaction with the service application 116.

### Request Handling

The request handling component 148 can represent logic and/or processes for implementing a workflow for handling a transport request 111 from requester devices 102. Depending on implementation, the request handling component 148 can implement multiple workflows for handing transport requests 111. Additionally, in some examples, the network computing system 100 can receive different types of transport requests 111, and the request handling component 148 can implement alternative workflows for handling the different types of transport requests 111.

In examples, network computing system 100 can operate to receive transport requests 111 for suggested trips, anticipated trips and/or confirmed trips. A suggested trip may correspond to a trip that is identified to the requester through the service application 116, based on the requester's current location and/or historical information about typical or recent trips which the requester has received. For example, the service application 116 can include processes that automatically identify and display information about suggested trips for the requester, in response to the requester opening the service application 116, or the requester opening a particular panel from which transport request can be made. In such implementations, some examples provide for the network computing system 100 to display service value information 121 which can include an estimate of a service value that may be charged to the requester for fulfillment of a transport requests for the suggested trip.

In order to obtain service value information 121 for a suggested trip, the network computing system 100 obtains service parameters for the suggested trip (e.g., the requester's current location, recent or common destinations of the requester when making trip requests). For a transport request 111 of the suggested trip, the request handling component 148 can include processes or logic to interface with the active service data store 130, in order to determine the default parametric value 125 for an area of the service start location 113. Based on the request parameters of the transport request 111, the baseline component 156 can utilize a map database or service to estimate a trip distance and/or duration from which a baseline value 157 for the suggested trip can be determined. The request handling component 148 can apply the default parametric value 125 to the baseline value 157 to determine service value information 121 which includes an estimated service value that may be charged to the requester for the suggested trip at that moment in time. In such examples, the baseline component 156 can also account for alternative types of transport service, with each type of transport service having its own baseline value determination.

An anticipated trip may correspond to a transport request 111 that the requester has signaled as wanting to make, but which the requester has to confirm before a service provider is committed to provide the transport for fulfilling the transport request 111. In some examples, the request handling component 148 can determine service value information 121 by interfacing with the active service data store 130 to determine the default parametric value 125 for an area of the service start location 113. The baseline component 156 can provide a baseline value 157 for the anticipated trip (which can also account for transport or service type), and the request handling component 148 can apply the default parametric value 125 to the baseline value 157 to determine the service value information 121. The service value information 121 can be returned to the requester device 102, so that the requester is able to determine the service value that may be charged to the requester in advance of confirming the transport request 111.

In variations, the request handling component 148 can handle a transport requests 111 for an anticipated trip by triggering a matching process to be performed by the matching engine 140. The request handling component 148 can communicate the service parameters for the transport request of the anticipated trip to the matching engine 140, and the matching engine 140 can perform a matching process (as described with other examples) to determine the parametric service value for the transport request. In some examples, the matching engine 140 performs a preliminary match to identify a service provider for the transport request 111. The request handling component 148 can identify the selected parametric value 105 of the matched service provider, and apply the selected parametric value 105 to the estimated baseline value 157 (as determined by the baseline component 156) to determine the service value information 121. In this way, the service value communicated for an anticipated trip can reflect situations where the selected parametric value 105 of a matched service provider is different than the default parametric value 125.

A confirmed trip may correspond to a transport request that is confirmed. In some implementations, the requester can interact with the service application to 116 to affirmatively communicate a transport request 111 that is confirmed. Further, in some implementations, the transport request 111 can be requested without service value information 121 being provided. For example, the transport request 111 can be monitored by the service monitor component 152 for determination of actual distance or duration of travel, and the determinations are used to determine the calculated service value 165.

In other implementations, a transport request 111 is confirmed once the requester device 102 is provided with service value information 121. Depending on implementation, the service value information 121 that is communicated to the requester device 102 in advance of the confirmed transport request 111 being made represents an upfront service value calculation that is charged to the requester. Additionally, in some variations, the service value information 121 that is communicated in advance of the transport request 111 being confirmed can be communicated to the service provider device 104 of the matched service provider. For example, the estimated service value information 121 can be communicated to the service provider device in a workflow where the service provider can accept or decline the transport request 111. Depending on implementation, the estimated service value information 121 can provide (i) an estimate of the calculated service value 165 which the service provider may receive as compensation for fulfilling the transport request, or (ii) an alternative to the calculated service value 165 which the service provider can receive as compensation for fulfilling the transport request.

In variations, the service value information 121 that is communicated to the requester device 102 in advance of the confirmed transport request 111 can be revised by the determination of a calculated service value 165 which is based on a measured distance or duration of the actual trip. For example, the calculated service value 165 can be used as a basis for compensating the service provider. As another example, the calculated service value 165 can be used as a basis for determining the service value charge to the requester.

In examples, the request handling component 148 can also implement one or multiple processes for matching requesters with service providers. In some examples, the request handling component 148 implements a matching process where a candidate service provider is selected for a particular transport request 111 (confirmed), and the service provider is provided an option to accept or decline the matched transport request. For example, matching engine 140 can receive service parameters of a confirmed transport request 111, perform a matching engine 140 using the service parameters of the transport request, and return a matched set 145 of service providers, which is the selected service provider. The request handling component 148 can transmit (or initiate transmission) of a service provider invitation 153 to the provider device 104 of the selected service provider. Depending on implementation and as described with some examples, the service provider invitation 153 can include service value information 121 for fulfilling the matched transport request, trip information for the matched transport request (e.g., service start location 113), and/or information about the requester. Once the service provider accepts the matched transport request (e.g., via reply message 163), the requester can be notified, and the service provider is provided information (e.g., service parameters or service start location 113) to initiate the transport service. In such examples, the estimated service value information 121 can be communicated to the service provider device 104 in advance of the service provider accepting the matched transport request 111.

In other examples, the request handling component 148 implements a matching process where a candidate service provider is selected for a particular transport request 111 (confirmed), and each of the requester and the service provider is provided a respective option to accept or decline the matched transport request. In such examples, the estimated service value information 121 can be determined and communicated to each of the requester device 102 and the provider device 104. In such examples, the matched service provider and corresponding expected service value information 121 (including expected calculated service value based on the selected parametric value 105 of the matched service provider) is provided to the requester device 102 as an invitation message 151. The requester can interact with the requester device 102 to accept or decline the matched service provider.

Still further, as described with some examples, the request handling component 148 can facilitate a matching process in which the matched set 145 of candidate service providers are provided to the requester device 102. In some variations, the request handling component 148 can calculate service value information 121 based on the selected parametric value 105 of each service provider. In this way, each candidate service provider of the matched set 145 can be provided to the requester device 102 with corresponding service value information 121, and the service value information 121 for some service providers of the matched set 145 may reflect different service values, based on the selected parametric value 105 of the respective service provider.

Additionally, in such examples, a requester may be provided with an ability to decline a matched service provider. For example, the requester device 102 may receive expected service value information 121 for a confirmed transport request 111. When a requester declines a matched service provider, the requester may be provided with an updated estimate or expected calculated service value, to enable the requester to make another transport request. Additionally, if no service providers are identified who can provide the transport service within an expected range (e.g., at or below the default parametric value 125), the update provided to the requester may identify a higher range for the requester's transport service.

In some examples, the request handling component can communicate a requester invitation 151 to the requester device 102, and a service provider invitation 153 to the service provider device 104. The requester invitation 151 can include information about the matched service provider (e.g., name, picture or other identifier) and service value information 121 that corresponds to an estimate of the service value charge which the requester will incur in exchange for the matched service provider fulfilling the requester's transport request. In some implementations, the requester invitation 151 can include additional information about the matched service provider, such as profile information about the service provider (e.g., level of experience) or the service provider's overall rating. Similarly, the provider invitation 153 can include information about the matched transport request 111, as well as service value information 121 that corresponds to an indication of the service value charge. The provider invitation 153 may, for example, display the portion of the service value charge which the service provider is expected to earn for completing the requester's transport request 111. Additionally, in some implementations, the provider invitation 153 can include information about the requester, such as the requester's age and gender, or a rating of the requester in connection with the requester receiving transport from other service providers.

Upon receiving the requester invitation 151, the requester can interact with the requester device 102, via the service application 116 to generate the reply 161 to accept or reject the requester invitation 151. Likewise, the service provider can interact with the provider device 104, via the service application 118, to generate the reply 163 to accept or reject the provider invitation 153. If either of the requester or service provider rejects the respective invitation message 151, 153, the matching engine 140 may perform another matching process to match the transport request 111 of the requester with a different service provider.

In examples, the requester and service provider invitations 151, 153 can be communicated at the same time, and each of the requester and service provider invitations 151, 153 can be associated with a corresponding timer. The request handling component 148 can monitor for affirmative responses (e.g., communicated by reply messages 161, 163, respectively) from each of the respective requester device 102 or service provider device 104. If no reply message 161, 163 is received from one or both of the requester device 102 or provider device 104, the request handling component 148 can record a predetermined default response from the non-responsive party. In variations, the requester and service provider invitations 151, 153 can be sequenced or serially communicated. In one implementation, the requester invitation 151 is initially communicated to the requester device 102, and once the requester is deemed to have accepted the pairing (e.g., via a reply message 161), then the invitation message 153 is communicated to the service provider device 104. In alternative implementations, the reverse sequence is employed—the service provider invitation 153 is communicated to the service provider device, and once the service provider is deemed to have accepted the pairing (e.g., via a reply message 163), then the invitation message 151 is communicated to the requester device 102.

In examples, once a service provider is matched to a transport request, the service state of the service provider is changed to reflect the matching. For example, the service monitor component 152 can change the service state of the service provider from one that reflects the service provider as being available to one in which the service provider is on-route to the service start location 113 and thus unavailable.

Additionally, in some variations, instances when requesters decline matched service providers may be recorded. For each such transport request, the request handling component 148 can, for example, identify the service parameters of the transport request, the default parametric value 125 in place when the requester declined, and the selected service parameter 105 of the service provider when the requester declined. Information about the declined matchings can be communicated back to the service providers, either individually as they occur (e.g., as an alert, such as in response to a requester declining a service provider), or in aggregate (e.g., by way of a report that aggregates the number of pairings in which requesters declined a particular service provider). In turn, service providers can utilize the feedback to modulate their selected parametric values 105 to improve their results, as desired.

### Matching Engine

In performing the matching process, the matching engine 140 can identify a candidate service provider or set of service providers that satisfy each of an arrival condition and service value condition for the transport request. As described in more detail, in some examples, once the matching engine 140 determines the matched service provider(s), the requester can make an additional selection to accept or decline the matched service provider. Additionally, the service provider can provide input to decline the matched transport request and/or the requester.

According to examples, the arrival condition can be based on a determination that a service provider can arrive and be available at the service start location 113 within a given time interval. Various factors may be taken into account in making a determination as to whether a service provider satisfies an arrival condition, including a current service state of the service provider and a current location of the service provider. In some examples, the service provider may be deemed to satisfy the arrival condition if the service provider is available and located in the same subregion as the service start location. In other examples, the service provider may be deemed to satisfy the arrival condition if the service provider is available and located within a minimum travel distance or time from the service start location. For example, each candidate service provider may be deemed to have an estimated time to arrival (ETA) at the service start location that meets a minimum threshold (e.g., within a threshold time interval). In some variations, the minimum ETA threshold that is used to determine the arrival condition may be adjusted based on, for example, a number of available service providers which are located within the minimum ETA threshold for a given transport request. Still further, the arrival condition can correspond to a determination that a service provider's arrival meets one or more criteria, such as (i) the service provider is deemed to be the likely earliest arrival, (ii) the service provider meets one or more preferences of the requester (e.g., type of vehicle, service provider rating, etc.). In some embodiments, the service value condition is based at least in part on the selected parametric value 105 of each service provider that satisfies the arrival condition. In an implementation, the service value condition can be based on a comparison of the selected parametric value 105 for each service provider that also satisfies the arrival condition. For example, the service value condition can be satisfied with the selected parametric value 105 that is lowest amongst those service providers who satisfy the arrival condition.

In some variations, the service value condition can be based on a determination that the selected parametric value 105 of the matched service provider is less than or equal to the default parametric value 125. Thus, to satisfy the service value condition, the selected parametric value 105 of the matched service provider may be either a fixed value that is equal to or less than the default parametric value 125, or the selected parametric value 105 may be set to be the default parametric value 125.

In some variations, the service value condition can include multiple sub-conditions. By way of example, the service value condition can correspond to the selected parametric value 105 being less than or equal to the default parametric value 125, but if no service provider satisfies the first sub-condition, then the service value condition can include a second sub-condition in which the service value condition is based on a comparative measure amongst the selected parametric value 105 of the service providers that satisfy the arrival condition. In such variations, if the determination of the first sub-condition yields no candidate service provider, the service value condition may provide for an additional criterion of the selected parametric value 105 of the matched service provider being the lesser amount of any other service provider that otherwise meets the arrival condition. To illustrate when the second sub-condition may apply, the matching engine 140 may identify no service providers for which the selected parametric value 105 is equal to or less than default parametric value 125, in which case the matching engine 140 identifies the service provider which has the selected parametric value that is the lowest amongst those service providers who satisfy the arrival condition. In such variations, the matched service provider would be able to satisfy the service value condition even though the selected parametric value 105 is a fixed value that exceeds the default parametric value 125.

According to an example, if the selected parametric value 105 of the matched service provider is set to be equal to the default parametric value 125, then service value for the matched service provider may be the same as the calculated service value provided with the expected service value information 121. If the selected parametric value 105 of the matched service provider is set to a fixed value that is less than the default parametric value 125, then the service value for the matched service provider is less than the calculated service value provided with the expected service value information 121. Similarly, if the selected parametric value 105 of the matched service provider is set to a fixed value that is greater than the default parametric value 125, then the service value for the matched service provider is greater than the calculated service value provided with the expected service value information 121. The matching engine 140 can use the comparison of the selected parametric value 105 with the default parametric view 125, as well as the estimated service value determination for individual service providers, to weight or factor for or against matching transport requests to individual service providers

In some examples, the matching engine 140 performs matching for a given area at discrete time intervals (e.g., 10 seconds, 30 seconds, 1 minute, 2 minutes), for transport requests which are received in that time interval. Still further, the matching engine 140 can queue incoming transport requests 111 for a given time interval (e.g., 10 seconds, 30 seconds, 1 minute, 2 minutes) before matching the transport request 111 to a candidate set of service providers. In some examples, the matching engine 140 can generate the matched set 145 of candidate service providers, with each service provider of the candidate set being associated with corresponding service value information 121 that is specific to that service provider. In an example, the candidate set includes a single matched service provider, and the service value information 121 identifies an estimate service value for the service provider to fulfill the transport request 111.

In variations, the matching engine 140 may implement alternative matching processes for matching transport requests and service providers. For example, the matching engine 140 can identify multiple candidate service providers that satisfy both the arrival and service value condition of a transport request. Assuming the selected parametric value 105 of each service provider of the candidate set is the same (e.g., the selected parametric value of each candidate service provider is set to the default parametric value 125, or to a fixed value that is equal to the default parametric value), then the matching engine 140 can use one or more additional criteria to determine the matched service provider for the transport request. The one or more additional criteria can include, for example, (i) a determination that the service provider is closer to the service start location 113, as compared to another service provider of the candidate; (ii) a determination that a profile or service preference of the requester matches to (or conversely matches against) a profile or service preference of one or more service providers of the candidate set; (iii) a determination that a profile or service preference of one or more of the candidate service providers matches to (or conversely matches against) a profile or service preference of the requester; (iv) a determination that a profile or service preference of one or more of the candidate service providers matches to (or conversely matches against) one or more service parameters of the transport request (e.g., service start and/or end locations 113, 115 are in subregions that are a stated preference of one of the service providers of the candidate set).

Still further, in some examples, if multiple candidate service providers are identified for a given transport request, the matching engine 140 may implement a matching process that is based on a system or group level optimization objective. For example, the matching engine 140 can queue the incoming transport requests from a given subregion or area for a given interval of time, and for each queued transport request, the matching process may be implemented to determine a candidate set of service providers which satisfy both an arrival condition and a service value condition. If multiple candidate drivers are identified for each of multiple transport requests (or for a group of requesters), then the matching engine 140 can match individual service providers to transport requests based on an objective of reducing the total wait time associated with the group of requesters as a whole. In such examples, the wait time can be based on, for example, an ETA for each service provider to travel to the service start location 113 of a corresponding transport request. When matching is implemented to further a system objective such as to minimize the wait time for a group of requesters, the pairings of individual service providers to requesters can be based on a determination that the wait time of the pairings as a group are minimized, rather than the wait time associated with individual pairings of the group being minimized. Thus, when the system objective is employed (e.g., minimize wait time for group of transport requests/requesters), individual requesters may not necessarily be matched to the closest service provider.

Additionally, in some examples, the requester may interact with the requester device 102 to specify input that can alter the matching process that is implemented for the requester's transport request. In an example, the requester can provide an input to have the matching engine 140 configure the matching process to disregard the service value condition, and to optimize for the arrival condition. For example, the requester can specify a setting where the transport request is initiated or fulfilled as soon as possible. In response, the matching engine 140 can identify the service provider that can arrive at the service start location 113 of the requester's transport service the soonest, without regard for whether or not the service provider meets a default service value condition.

In other variations, the requester can specify input that sets a limit on the service value condition. For example, the requester can specify a limit on the service value condition, where the limit exceeds the calculated service value that is determined by the default parametric value 125. In response, the matching engine 140 can configure the matching process so that the selected service provider is optimized for ETA, subject to the selected parametric value 105 of the service provider not causing the limit on the service value condition to be exceeded.

Still further, the requester can specify input that sets a limit on the service value condition, where the limit is less than the calculated service value that is determined from the default parametric value 125. In such example, the matching process may match the transport request of the requester to the service provider with the selected parametric value 105 that is fixed and less than the default parametric value 125.

Still further, in some examples, the matched set 145 of candidate service providers 145 can be communicated to the requester device 102, along with service value information 121 that reflects a calculated service value that may be charged to the requester in connection with individual service providers of the matched set 145 being selected to fulfill the transport request 111. For example, each identified service provider of the candidate set can be associated with corresponding service value information 121, reflecting, for example, the selected parametric value 105 of the service provider and the expected baseline value (e.g., trip distance and/or duration for the corresponding trip). Alternatively, multiple service providers of the candidate set may be associated with the same service value information 121, such as in the case where multiple service providers have set their respective selected parametric values 105 to be the same as the default parametric value 125. As an addition or variation, the matched set of service providers is communicated to the requester with the requester invitation 151, and the user's selection of one of the multiple candidate service providers results in the provider invitation 153 being generated for the selected service provider.

### Actual or Calculated Service Value

As described with some examples, the service value information 121 that is communicated to the requester device 102 and to the service provider device 104 in advance of the transport request being fulfilled can an estimate of the service value that will be calculated once the transport service is performed (or completed). Once transport is initiated by a service provider for a transport request, the service value for fulfillment of the transport request is calculated, by applying the selected parametric value 105 of the matched service value to a baseline value that is determined through monitoring of transport service being provided.

In examples, the service monitor component 152 can interface with the active service data store 130 to monitor the transport service provided by individual service providers. For example, the service monitor component 152 can monitor a matched service provider (as well as a matched requester) once the service state of the service provider changes to reflect the transport service as having been initiated (e.g., on-trip service state). The service monitor component 152 can interface with the active service data store 130 to monitor for time-stamped location information, such as provided by the service provider device 104 repeatedly communicating its current location 107 via the provider device interface 112 during an interval in which the service provider is on-trip to fulfill a matched transport request. Once the trip is complete (e.g., service provider signals that the transport request is fulfilled), the service monitor component 152 can use the time-stamped location information to determine a distance and time of travel for the service provider.

For a monitored trip, the baseline value can be determined by application of a base rate to a duration and/or distance of travel. The base rate can be implemented as a static formula that calculates a base rate value for a completed transport request based on trip time and distance. Based on the distance and time of travel, the service monitor component 152 can determine a baseline value for the trip, and the service monitor component 152 can determine a calculated service value 165 for the trip by applying the selected parametric value 105 of the service provider to the baseline value.

In examples, the calculated service value 165 can be communicated to an accounting component 158. The accounting component 158 can implement processes to, for example, can distribute a portion of the calculated service value 165 to a receiving account of the service provider.

### Methodology

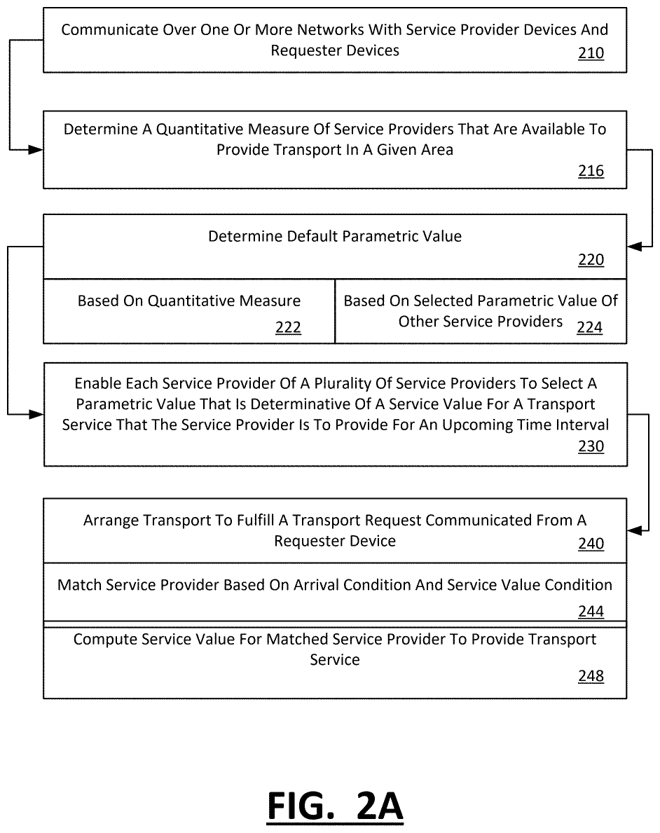

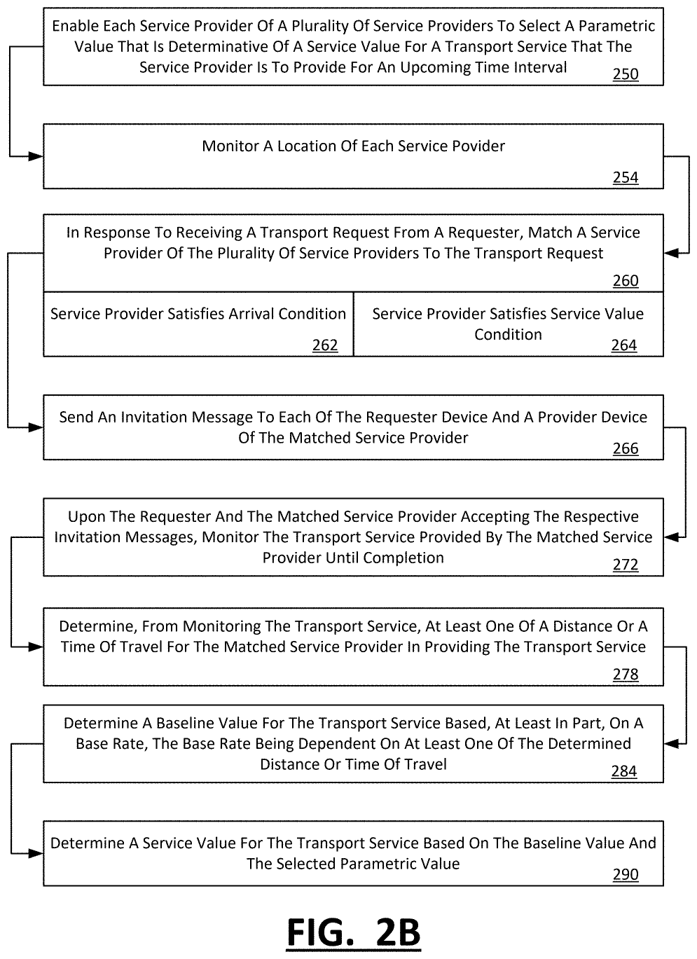

FIG. 2A illustrates an example method for arranging service providers to fulfill transport requests of requesters. FIG. 2B illustrates another example method for arranging service providers to fulfill transport requests of requesters. Example methods such as described with FIG. 2A and FIG. 2B may be implemented using a network computing system such as described with FIG. 1. Accordingly, in describing example methods of FIG. 2A and FIG. 2B, reference may be made to elements of FIG. 1 for purpose of illustrating suitable components or sub-components for performing a step or sub-step being described.

With reference to an example of FIG. 2A, the network computing system 100 communicates, over one or more networks, with a plurality of service provider devices and a plurality of requester devices (210). The network computing system 100 can communicate with service provider devices 104 to determine the current location 107 of each service provider and track the status of each service provider. Additionally, network computing system 100 communicates with the requester devices 102 to detect transport requests 111, as well as activities of the individual requesters that are indicative of the requester having intent to transmit a transport request 111 for the network computing system 100. As described with some examples, the activities may correspond to individual requesters opening and/or interacting with the service application 116 on their respective requester device 102

In examples, the network computing system 100 determines a quantitative measure of service providers that are available in the given area to provide transport services (216). As described with other examples, the quantitative measure can be based on (i) a number of service providers that are located in or near the given area, (ii) a number of service providers that are available to provide transport services from the given area, (iii) a number of requesters that are located within the given area, such as requesters who have opened the service application 116 on their respective requester devices 102, and/or (iv) historical information reflecting a number of available service providers and/or requesters data that are present in the given area for a relevant time interval. As an addition or variation, the historical information can include information that reflects a conversion response by requesters to a service value determination, where the conversion response reflects a number of requesters who confirmed transport requests after being provided service value information 121 (e.g., as an estimate) as compared to requesters who did not confirm transport requests after being provided service value information 121. This determination can also be made specifically for a particular area or region and/or relevant time period. In other variations, the conversion response can be determined more generally as a measure of a particular parametric value (e.g., multiplier to baseline value), or as a comparative measure vis-à-vis the default parametric parameter.

The network computing system 100 determines a default parametric value 125 for the given area and a given time interval (e.g., 5 second interval, 1 minute interval, etc.) (220). In examples, the default parametric value 125 is based at least in part on the quantitative measure of service providers (222). As an addition or variation, the default parametric value be based on the selected parametric value 105 of some or all the service providers that are available to provide transport or otherwise in the given area (224). To illustrate, if many or all of the available service providers of the given area have selected parametric values 105 that are fixed and which differ from the default parametric value 125, the network computer system 100 can update the default parametric value to reflect, for example, a minimum value amongst the fixed parametric values of the available service providers. The network computing system 100 can repeatedly determine the default parametric value 125 for the given area over successive intervals (e.g., every 5 seconds, every 1 minute, etc.).

In examples, the network computing system 100 enables individual service providers to select a parametric value 105 from which a service value can be determined for transport services provided by that service provider from the given area (230). Each service provider can operate a corresponding service provider device 104 to select the parametric value 105 from multiple possible parametric values. As described with some examples, the selected parametric value 105 of a service provider can correspond to a multiplier (e.g., 1.1×, 1.5×, 1.8×, etc.) or an adder (e.g., +$3.00, +5%, etc.). Additionally, the selected parametric value can be fixed, dynamic, or set to a range (e.g., dynamic value with fixed minimum). As a dynamic value, the selected parametric value 105 can be based on or correspond to the default parametric value 125 for an area where a transport service is to be initiated, as determined by the network computing system 100 for successive time intervals.

In this way, the default parametric value 125 can be associated with a predetermined area of a region, or subregion, and the value may be dynamic as it is recalculated at each successive interval. In a given region (e.g., city), the network computing system 100 can determine one or multiple areas (e.g., city blocks, airport sub-region, etc.) where associated default parametric values 125 are determined.

In examples, network computing system 100 can communicate the default parametric value 125 to the requester devices 102 that are in or within a threshold proximity of a predetermined area that is associated with the default parametric value 125. For example, the network computing system 100 can publish a map for service provider devices 104 that indicates the determined default parametric value 125 of a given area (or multiple areas of the given region) during a current time interval. The service providers may then refer to the map to adjust or set their selected parametric value 105.

Thus, for example, a service provider can operate a vehicle to travel to an area where a default parametric value 125 is actively being determined by the network computing system 100. The service provider can view the default parametric value 125 by opening the service provider application 118 on his or her respective device 104. Additionally, the service provider can change or update the selected parametric value 105, based on the default parametric value 125 communicated by the network computing system 100, through an interface provided by the service application 118. For example, the service provider can change the selected parametric value 105 to be equal to the default parametric value 125 based on fluctuations of the default parametric value 125 over successive time intervals.

According to examples, the network computing system 100 arranges transport to fulfill a transport request communicated from the requester device of a requester (240). In arranging the transport, the network computing system 100 can match a service provider based on the service provider satisfying each of an arrival condition of the transport request, and a service value condition that is indicative of a service value that can be computed for the matched service provider to fulfill the transport request (244). The determination of the matched service provider satisfying the arrival condition can be based on, for example, the current location of the matched service provider and the service start location of the service request.

The determination that the matched service provider satisfies the service value condition can include one or multiple determinations. In an implementation, the matched service provider can be deemed to satisfy the service value condition by having his or her selected parametric value 105 be equal to or less than the default parametric value 125. Thus, for example, the matched service provider may have previously set the selected parametric value 105 to be the same as the default parametric value 125. As the default parametric value 125 changes over successive time intervals, the selected parametric value 105 of the matched service provider also changes, but the two values remain the same. As another example, the matched service provider may have set the selected parametric value 105 to be fixed at a value that is less than the default parametric value 125.

As still another example, the matched service provider may have set the selected parametric value 105 to be equal to the default parametric value 125, provided that the default parametric value 125 is greater than or equal to a minimum amount specified by that service provider. In such an example, the service provider may provide the floor value for his or her selected parametric value 105, and the matched service provider satisfies the service value condition when the default parametric value 125 is greater than or equal to the specified floor value.

Still further, in other examples, the service value condition can be based on one or more determinations relating to the selected parametric value 105 of service providers in the given area of the transport request. For example, in the event that the service providers in the given area have the selected parametric value 105 set to be greater than the default parametric value 125, the service value condition can correspond to (i) a determination that the selected parametric value 105 of the matched service provider is lowest, or within a threshold value of the lowest selected parametric value of other service providers who are candidates for matching to the transport request; or (ii) a determination that the selected parametric value 105 of the matched service provider is less than an average of the selected parametric value of other candidate service providers of the transport request. In such examples, the candidate service providers for the transport request can correspond to those service providers who satisfy the arrival condition.

Additionally, the network computing system 100 can, in connection with arranging transport to fulfill the transport request of the requester, compute the service value for the matched service provider to provide the transport service (248). In some examples, the service value can be based on the default parametric value 125, the service start location and the service and location.

In some examples, when the selected parametric value 105 is different than the default parametric value (e.g., fixed value that is less than the default parametric value 125), the network computing system 100 can compute a service value for fulfillment of the transport request which is based on the selected parametric value 105, as well as the service start location and service and location of the transport request.

In some examples, the network computing system can compute the service value in advance of the requester making or confirming the transport request. For example, the requester can operate the service application 116 on the requester device 102, and the service application 116 can include logic that anticipates the requester's intended destination (e.g., based on historical information). In such examples, the service application 116 can execute to enable the requester to confirm a transport request as between, for example, the requester's current location and the anticipated service end location of the requester. In enabling the requester to confirm the transport request, the network computing system 100 can compute the service value based on an estimated travel distance and/or duration, as well as the default parametric value 125 for the area of the service start location.

As an addition or variation, the network computing system 100 can compute the service value for the transport service by monitoring this matched service provider to determine a baseline value for the provide transport service. For example, the network computing system 100 can monitor the matched service provider to determine a distance and/or time or duration of travel between a service start and service and location of the transport request. The baseline value for the provided trip can be based on trip distance and/or duration. The selected parametric value 105 of the matched service provider can be applied to the baseline value to determine the service value for the transport service that was provided.

In some examples, the determined service value for the transport service that is determined from monitoring the actual distance/time of travel can correlate to the compensation (e.g., funds) the service provider is provided for fulfilling the transport request. In variations, the determined service value for compensation provided to the transport provider can be based on the estimated service value that is determined in advance (e.g., before requester makes or confirms transport request), using the service start location, and service end location, default parametric value 125.

In some examples, the service value that is charged to the requester can correspond to the service value that was estimated in advance of this requester making or confirming the transport request. In other examples, the service value that is charged to the requester can correspond to the service value that is calculated form monitoring the transport provided for actual distance and/or trip duration.

With reference to an example method of FIG. 2B, network computing system 100 enables each service provider of a plurality of service providers to select a parametric value that is determinative of a calculated service value for a transport service that the service provider may provide for an upcoming or future time interval (250). In one implementation, a service provider can select a service value that is fixed, so as to not change unless by the service provider.

In other implementations, the service provider can select a parametric value that is dynamic, such as one that is set to a default parametric value which the network computing system 100 can determine at repeated intervals, for subregions and areas of a geographic region. As described with an example of FIG. 1, the default parametric value 125 can be based on comparative measures of requesters and service providers. The service provider can select to have an associated parametric value (or selected parametric value 105) be the same as the default parametric value 125. In response, the network computing system 100 can automatically associate the selected parametric value of the service provider to be the same as the default parametric value, given the location of the service provider and/or time when the determination is made.

As an addition or variation, the service provider can select the parametric value to have a range of values, with a lower range being a fixed value, and the upper range being a dynamic value (e.g., the default parametric value 125). In such implementations, the service provider can be matched to transport requests so long as the default parametric value 125 is greater than the lower fixed value of the service provider's selected parametric value 105.

As described with some examples, the selected parametric value 105 of a service provider can result in a service value charge that (i) is equal to the base rate value if the applied multiplier is 1, (ii) is greater than the base rate value if the applied multiplier is greater than 1, or (iii) is less than the base rate value if the applied multiplier is less than 1. In variations, the selected parametric value can be implemented as a differential amount which can be added or subtracted from the base rate value. Still further, in other variations, the selected parametric value 105 of a service provider can correspond to another form of modifier to the baseline value determination.

The network computing system 100 monitors each of the plurality of service providers (254). In examples, the network computing system monitors individual service providers for their current location and their service state. For example, the service application 118 executing on the service provider device 104 can repeatedly and automatically sample a satellite receiver of the service provider device 104 to communicate a current location of the service provider. Additionally, the activities of the service provider can be tracked to determine the service state of the service provider. By way of example, the service provider can provide affirmative input to indicate when the service provider is on-route (e.g., the service provider accepts a transport request) or on-trip (e.g., the service provider provides input to mark the start and end of a transport service). The provided device interface 112 can receive the current location and inputs of the service provider to update the active service data store 130, so that a record of the service provider reflects a current location and service state of the service provider.

As described with examples, the network computing system 100 matches individual service providers with transport requests of requesters (260). In matching a service provider with a transport requests, the network computing system 100 determines that the service provider satisfies each of an arrival condition (262) and a service value condition (264) for the matched transport request. The arrival condition can include one or more criteria regarding a time when the service provider can arrive and be available at the service start location 113 of a transport request. The service value condition can include one or more criteria regarding the calculated service value of the service provider, in connection with a transport service provided by the service provider.

When a service provider is matched to a transport request, the network computing system 100 sends an invitation message to each of the requester device and the provider device (266). In examples, the invitation messages can be communicated through the corresponding service applications 116, 118 that execute on the respective requester and provider devices 102, 104. Each of the service provider and requester can respond to the respective invitation message with a reply that accepts or rejects the matching. If no reply is given, the network computing system 100 can assume a default reply, which can be predetermined to be either accept or decline.

In an implementation, the invitation messages can be sent to the requester and provider devices 102, 104 at the same time, and the pairing may occur once both requester and service provider are deemed to have accepted (either through reply message or by default no-action designation). Alternatively, the network computing system 100 may first communicate an invitation message to the service provider device 104, then communicate the invitation message to the requester device 102 once the service provider is deemed to have accepted. As another alternative, the network computing system 100 may first communicate an invitation message to the requester device 102, then communicate the invitation message to the provider device 104 once the requester is deemed to have accepted.

Upon the requester and the matched service provider accepting the respective invitation messages, the network computing system 100 monitors the transport service provided by the matched service provider until completion (272). In examples, the service monitor component 152 can monitor location information associated with the service provider, such as provided by the provider device 104 repeatedly transmitting its time-stamped current location to the provider device interface 112, so that the location and associated time stamp of the service provider is recorded with the active service data store 130 from the moment when a trip starts (e.g., service provider indicates that the requester has entered the vehicle) until when the trip ends (e.g., service provider indicates that the transport service has completed).

The network computing system 100 determines, from monitoring the transport service, at least one a distance or a time of travel for the matched service provider in providing the transport service (278). The service monitor component 152 can use the time-stamped location information for a given trip to approximate each of the distance and time of travel.

The network computing system 100 determines a baseline value 157 for the transport service based, at least in part, on a base rate, where the base rate is dependent on at least one of the determined distance or time of travel (284). In variations, the baseline value 157 may also be dependent on a route which the service provider used in providing the transport, as well as other parameters such as the time of day or day or week.

The network computing system 100 calculates a service value for the transport service based on the baseline value 157 and the selected parametric value (290). In examples, the determined service value includes a service value determination can correspond to a service value that is charged to the requester, and a portion of the service value charge that is to be provided to the service provider as compensation for providing the transport service.

### User Interface Examples

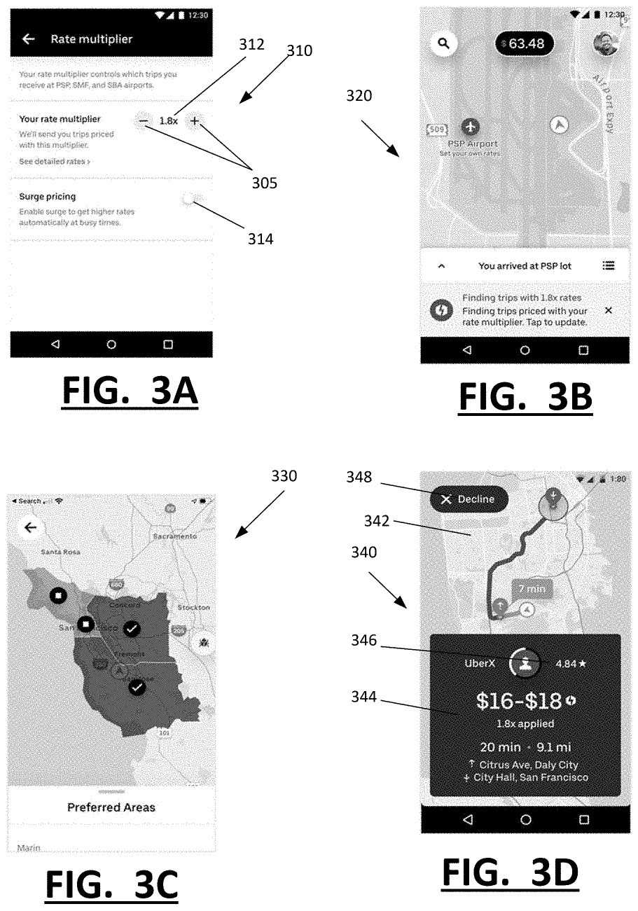

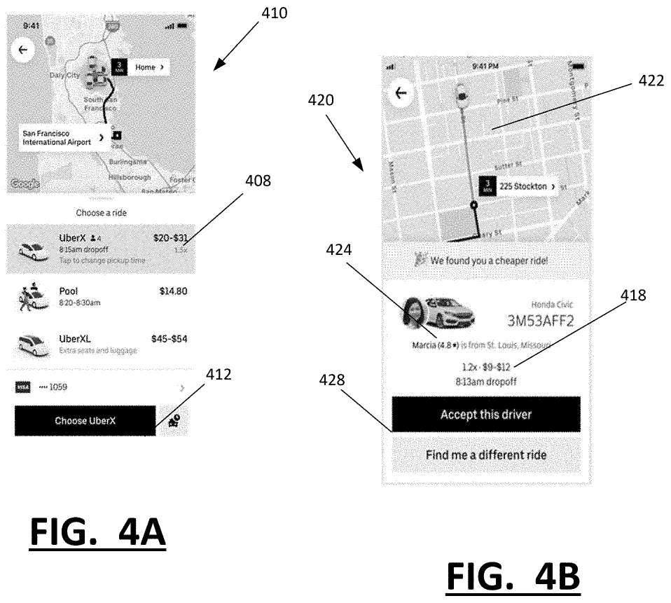

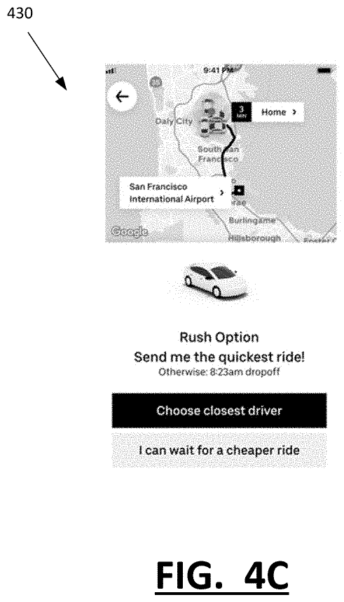

FIG. 3A through FIG. 3D illustrate user interfaces for a service provider device, according to one or more examples. FIG. 4A and FIG. 4B illustrate user interfaces for a requester device, in connection with a matching process implemented through the network computing system 100, according to one or more examples. FIG. 4C illustrates a user interface for a requester device, in connection with a requester specifying input to alter or configure a default matching process. In describing examples of FIG. 3A through FIG. 3D, FIG. 4A and FIG. 4B, and FIG. 4C, reference may be made to elements of FIG. 1 for purpose of illustrating suitable components for implementing functionality as shown by the example user interfaces.

FIG. 3A illustrates an example interface 310 for enabling a service provider to specify input for the service provider's selected parametric value 105. In an example shown, the service provider can manipulate one or more features 305 to increase or decrease a multiplier of the selected parametric value 105. In variations, the selected parametric value 105 can be in an alternative form which can be adjusted by the feature(s) 305. For example, the selected parametric value 105 can be implemented as a differential amount which can be added or subtracted from a baseline value to provide the service value.

With further reference to an example of FIG. 3A, the selection interface 310 can include a fixed rate feature 312 for enabling the service provider to specify that the selected parametric value 105 is a fixed value. As an addition or variation, the selection interface 310 can include a dynamic rate feature 314 that can be selected to have the selected parametric value 105 be equal to the default parametric value 125. In variations, the service provider can select both a fixed value and a dynamic value for the selected parametric value 105. In such variations, the value identified by the fixed rate feature 312 identifies the lowest selected parametric value 105 of the service provider, and the value identified by the dynamic rate feature 314 means the value of the selected parametric value 105 is equal to the default parametric value 125, so long as the default parametric value 125 is greater than the value of the fixed rate feature 312.

In examples, a service provider can update their respective selected parametric value 105 through interaction with the service application 118, executing on the service provider device 104. FIG. 3B illustrates an example status interface 320 that is automatically generated by the network computing system 100, through the service application 118 executing on the service provider device, to alert the service provider of the service provider's current selected parametric value 105. The service provider can interact with the status interface 320 to alter their selected parametric value 105. In an implementation, the status interface 320 can be generated periodically at one or more instances during, for example, the service provider's shift. In another implementation, the status interface 320 can be generated after the service provider fulfils a set number of transport requests.

In examples, a service provider can interact with the service application 118 to specify additional preferences of the service provider with regards to the transport requests that are matched to the service provider. As an example, FIG. 3C illustrates a preference panel 330 for a service provider. In an example shown, the service provider can interact with the preference panel 330 to specify a preference as to a geographic region or subregion where the service provider prefers to operate a vehicle in. In response to receiving preferences from the service provider, the matching engine 140 can, for example, weight or otherwise favor matchings for a corresponding service provider so that the service provider receives more matchings to transport requests that are within the preferred regions of the service provider. As described with some examples, the use of preference panels can enable the matching engine 140 to implement matching processes that take in account the preferences of requesters and service providers, resulting in fewer cancellations and other benefits.

FIG. 3D illustrates an example of an invitation interface 340 for displaying a service provider invitation that identifies a matched transport request for the service provider. By way of example, the invitation interface 340 can display content corresponding to the provider invitation 153. In examples, the invitation interface 340 can include map content 342, which may display the service start and end locations 113, 115), as well as content 344 that includes the service value information 121 for the transport request. In examples, the content 344 can identify a portion of a calculated service value which the service provider can be expected to receive as compensation for fulfilling the identified transport request. The content 344 may reflect a range in values to reflect, for example, possible variations of a baseline value for the service provider to complete the identified transport request. The invitation interface 340 may also include requester information 346, such as the rating of the requester that is associated with the matched transport request. Additionally, the invitation interface 340 can be provided with a response feature 348, which the service provider can interact with to generate a response to the provider invitation. The service provider may, for example, use the response feature 348 to accept or reject the matched transport request.

With reference to FIG. 4A, a requester interface 410 can be displayed to the user in response to a requester activity. By way of example, the requester interface 410 can be generated in response to user activity, such as the requester opening the service application 116 on the requester device 102, or the user providing input that indicates the user is interested in receiving transport between a specified service start and end locations 113, 115, which can be indicated using map content that displays an expected route for the service provider. The requester interface 410 can display an estimate 408 of a calculated service value for an anticipated or possible transport request of the requester. In examples, the calculated service value of the estimate 408 may be based on the default parametric value 125 that is determined for the particular time interval and location of the transport request. As described with some examples, the estimate 408 can be determined without service provider specific information.

Furthermore, as shown with an example of FIG. 4A, the estimate 408 may include service value information 121 for one or more types of services that are available to the requester, based on the location of the requester. Each type of service may, for example, have alternative base rates. Additionally, as different service providers may provide different types of services, the default parametric value 125 for each type of transport service may be different.

As shown by an example of FIG. 4A, the requester may interact with the requester interface 410 by selecting a request feature 412. With selection of request feature 412, the service application 116 can confirm a transport request of the requester, based on, for example, the indicated service start and end locations, 113, 115. The requester can further interact with the requester interface 410 to specify or modify one or more service parameters before confirming the transport request 111. For example, the requester may select a service type or level, or change a service start location of the transport request.

As show in an example of FIG. 4A, the service value information 121 can be based in part on the default parametric value 125, as applied to a range of baseline values for a given service provider that is to fulfill the service request. The range of baseline values can be based on an estimation of variation in terms of the duration and/or distance traveled for transport between the service start and end locations 113, 115. In variations, the service value information 121 can be based on an average of the selected parametric value 105 for a set of available service providers in a vicinity of the requester. In other variations, the service value information 121 can be based on the selected parametric value 105 of an expected service provider that will be matched to the requester to fulfill the transport request.

FIG. 4B illustrates an example of an invitation interface 420 for displaying a requester invitation that identifies a matched service provider for a transport request of the requester. The invitation interface 420 can provide an updated calculated service value 418 for a transport request 111 that was requested by the requester, where the calculated service value 418 is based on the selected parametric value 105 of the matched service provider. For example, the calculated service value 418 can provide an estimate of the calculated service value which will likely be charged to the requester for having the transport request fulfilled by the matched service provider, given the selected parametric value 105 of the requester and the expected baseline value for fulfilment of the transport request. While in some implementations, the updated calculated service value 418 is provided as an estimate (e.g., pending determination of base rate values, etc.), in variations, the calculated service value 418 can be provided as a fixed amount.

The calculated service value 418 may be generated to provide information communicated by the invitation message 151. In examples, the requester invitation 151 can correspond to a message rendered through the service application 116, running on the requester device 102. In addition to the calculated service value 418, the invitation interface 420 can display content corresponding to the requester invitation 151, which may include (i) map content 422 to display information about the transport request of the user, and (ii) content 424 about the matched service provider, such as an identifier and rating of the matched service provider. The invitation interface 420 can provide the requester invitation 151 with a response feature 428 that enables the user to respond to the requester invitation 151. The requester's response can either accept or reject the matched service provider.

FIG. 4C illustrates an example of a requester interface 430 for enabling the requester to alter or configure a matching process of a matching service provided by the network computing system 100. In an example of FIG. 4C, the requester can interact with requester interface 430 (which may be generated by the service application 116 on the requester device 102) to select an option in which the requester receives the soonest available transport provider. To implement such a requester option, the matching engine 140 can disregard the service value condition for the available service providers, so that the pool of available service providers is maximized. The matching engine 140 can then select from the available pool the service provider who has the lowest ETA to the service start location 113 of the transport request (or current location of the requester).

### Hardware Diagram

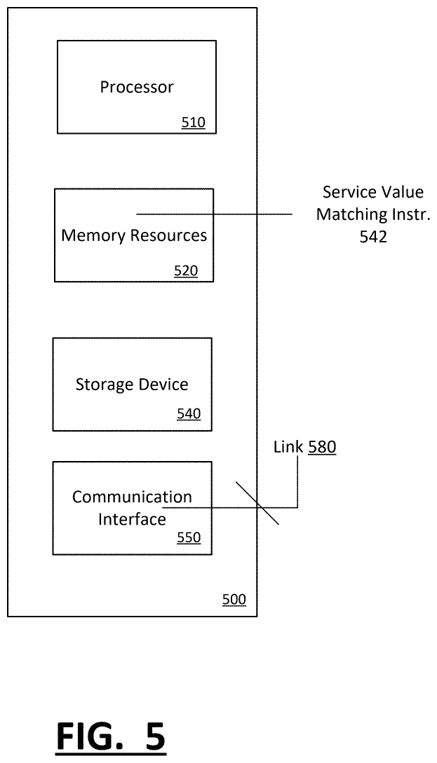

FIG. 5 is a block diagram that illustrates a computer system upon which one or more embodiments described herein may be implemented. For example, in the context of FIG. 1, the network computing system 100 may be implemented using a computer system or combination of computer systems, such as described with an example of FIG. 5. Additionally, a method such as described with an example of FIG. 2 may be implemented using a computer system such as described with an example of FIG. 5.

In one implementation, the computer system 500 includes one or more processors 510, memory resources 520, and a communication interface 530. The computer system 500 includes at least one processor 510 for processing information. The memory resources 520 may include a random-access memory (RAM) or other dynamic storage device, for storing information and instructions to be executed by the processor(s) 510. The memory resources 520 also may be used for storing temporary variables or other intermediate information during execution of instructions to be executed by the processor(s) 510. The computer system 500 may also include other forms of memory resources, such as static storage devices for storing static information and instructions for the processor 510. The memory resources 520 can store information and instructions, including instructions 542 for determining provisioning levels and positioning operations, in order to implement, for example, a transport matching service. Additionally, the processor(s) 510 can execute the instructions 542 to implement a method such as described with an example of FIG. 2.

The communication interface 530 can enable the computer system 500 to communicate with one or more networks 580 (e.g., cellular network) through use of the network link (wireless or wireline). Using the network link, the computer system 500 can communicate with one or more other computing devices and/or one or more other servers or data centers. In some variations, the computer system 500 can receive transport requests from requester devices via the network link 580. Additionally, the computer system 500 can receive information from provider devices, from which forecasts of provisioning levels, location bias and other aspects described herein may be determined.

Examples described herein are related to the use of the computer system 500 for implementing the techniques described herein. According to one embodiment, those techniques are performed by the computer system 500 in response to the processor 510 executing one or more sequences of one or more instructions contained in the memory resources 520. Such instructions may be read into the memory resources 520 from another machine-readable medium, such as the storage device. Execution of the sequences of instructions contained in the memory resources 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

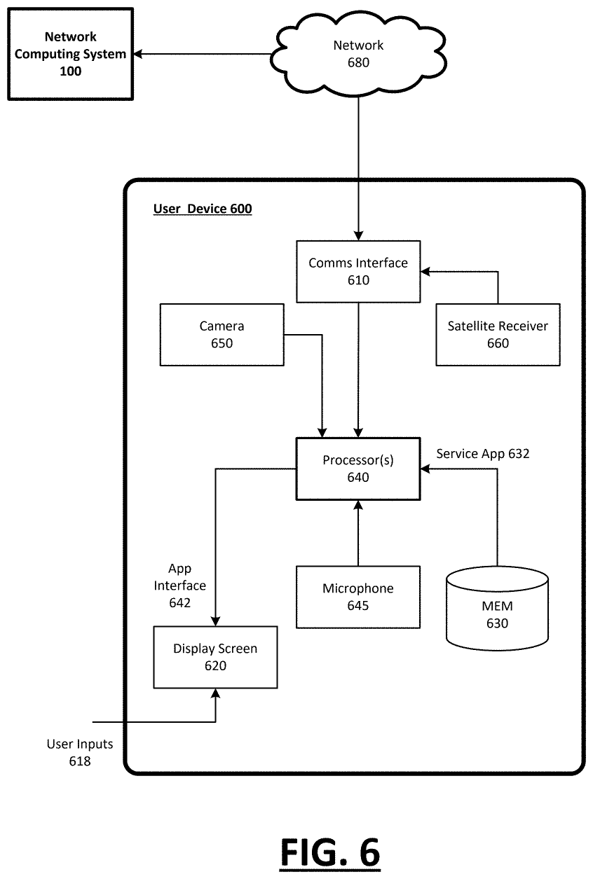

FIG. 6 is a block diagram illustrating an example user device for use with examples as described. In an example, a user device 600 can correspond to a requester device 102 or service provider device 104. Accordingly, the user device can execute a respective service application 116, 118 for enabling the user to access and use the network computing system 100 as a requester or service provider.

In many implementations, user device 600 can include a mobile computing device, such as a smartphone, tablet computer, laptop computer, VR or AR headset device, and the like. As such, the user device 600 can include typical telephony and/or tablet features such as a microphone 645, a camera 650, a satellite receiver 660, and a communication interface 610 to communicate with external entities using any number of wireless communication protocols (and over one or more networks). In certain aspects, the user device 600 can store the designated application (e.g., a service app 632) in a local memory 630. In variations, the memory 630 can store additional applications executable by one or more processors 640 of the user device 600, enabling access and interaction with one or more host servers over one or more networks 680.

In response to a user input 618 (e.g., search input), the service application 632 can interact with the user device 600 to display an application interface 642 on a display screen 620 of the user device 600. By way of example, when the user device 600 is a requester device 102, the user can use the application interface 642 to make transport requests, view service value information 121 and/or view information about matched service provider(s). When the user device is a provider device 104, the user can use the application interface to view, for example, the default parametric value 125, the selected parametric value of the service provider, service value information 121 for a matched service request, feedback regarding a declined matching, and/or other information provided by the network computing system 100 in connection with the service provider's access and use of the network computing system 100.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computing system comprising:
one or more processors;
memory resources to store a set of instructions;
wherein the one or more processors access the set of instructions to:
communicate, over one or more networks, with (i) a plurality of service provider devices to determine a current location of each service provider device of a plurality of service providers, and (ii) a requester device of a requester to receive a transport request, the transport request specifying at least one of a service start location or service end location;
determine, from the current location of each service provider during a given time interval, a quantitative measure of service providers that are available in a given area to provide transport services;
determine, for the given area and a given time interval, a default parametric value that is based at least in part on the quantitative measure of service providers;
enable each service provider of the plurality of service providers to select a parametric value of multiple possible parametric values for the given area, wherein the multiple possible parametric values include the default parametric value; and
arrange transport to fulfill a transport request communicated from the requester device of the requester, including matching a service provider of the plurality of service providers to the transport request, based on a determination that the matched service provider satisfies each of (i) an arrival condition for the transport request of the requester, the arrival condition being based, at least in part, on a current location of the matched service provider and at least one of the service start location or the service end location; and (ii) a service value condition that is indicative of a service value that can be computed for the matched service provider to fulfill the transport request of the requester;
wherein in connection with the one or more processors arranging transport to fulfill the transport request, the one or more processors compute the service value based on the default parametric value, the service start location, and the service end location.

2. The network computing system of claim 1, wherein the one or more processors compute the service value for the transport request upon completion of the matched service provider fulfilling the transport request.

3. The network computing system of claim 2, wherein the one or more processors compute the service value by:
monitoring the transport service provided by the matched transport requester until completion; and
determine, from monitoring the transport service, at least one of a distance or a time of travel for the matched service provider in providing the transport service;
determine a baseline value for the transport service based on at least one of the determined distance or time of travel; and
determine a service value charge for the transport service based on the baseline value and the selected parametric value of the matched service provider.

4. The network computing system of claim 2, wherein the one or more processors compute the service value for the transport request as an estimate, before the transport service is initiated or confirmed.

5. The network computing system of claim 1, wherein the one or more processors determine the default parametric value based at least in part on an estimated number of service providers that are available in the given area at the given time interval to provide transport services.

6. The network computing system of claim 5, wherein the one or more processors determine the default parametric value based at least in part on a number of requesters that are in the given area during the given time interval, and comparing the estimated number of service providers with an estimated number of requesters.

7. The network computing system of claim 1, wherein the one or more processors determine the default parametric value based at least in part on a selected parametric value of multiple service providers that are available in the given area at the given time interval to provide transport services.

8. The network computing system of claim 1, wherein the one or more processors determine the service value condition based on the default parametric value.

9. The network computing system of claim 8, wherein the one or more processors execute the instructions to:
in response to receiving the transport request, determine the service value condition to be based on the default parametric value if one or more service providers satisfy the arrival condition and have respective selected parametric values that are equal to or less than the default parametric value;
else determine the service value condition to be based on a lowest selected parametric value amongst one or more service providers that satisfy the arrival condition.

10. The network computing system of claim 1, wherein the service value condition includes a determination that the selected parametric value of the service provider is less than or equal to the default parametric value.

11. The network computing system of claim 1, wherein the service value condition includes a determination that the computed service value that will be charged to the requester for the transport service is less than a maximum amount specified by the requester.

12. The network computing system of claim 1, wherein the service value condition includes a first determination that a selected parametric value of each service provider of multiple candidate service providers that is available to fulfill the transport request of the requester is greater than the default parametric value.

13. The network computing system of claim 12, wherein the service value condition includes a second determination that the selected parametric value of the matched service provider satisfies another condition as between the selected parametric value of the multiple candidate service providers.

14. The network computing system of claim 13, wherein the second determination includes one of (i) the selected parametric value of the matched service provider being a lowest of the selected parametric values of the matched service providers, or (ii) the selected parametric value of the matched service provider being less than an average of the selected parametric value of the matched service providers.

15. The network computing system of claim 1, wherein the one or more processors enable each service provider of the plurality of service providers to select the parametric value by enabling each service provider to select at least one of (i) a fixed parametric value, or (ii) a dynamic parametric value, wherein the dynamic parametric value is based on or equal to the default parametric value.

16. The network computing system of claim 1, wherein the one or more processors enable each service provider of the plurality of service providers to select the parametric value by enabling each service provider to select a dynamic parametric value that is based on or equal to the default parametric value, with a minimum value that is specified by the service provider.

17. The network computing system of claim 1, wherein the one or more processors enable one or more of the plurality of service providers to select multiple parametric values, each parametric value being for a type of transport service that the one or more service providers is capable of providing.

18. The network computing system of claim 1, wherein the one or more processors repeatedly determine the default parametric value over successive time intervals, and communicate the default parametric value to the service provider device of each service provider of the plurality of service providers during each time interval of the successive time intervals.

19. A non-transitory computer-readable medium that stores instructions, that when executed by one or more processors of a network computing system, cause the network computing system to perform operations that include:
communicating, over one or more networks, with (i) a plurality of service provider devices to determine a current location of each service provider device of a plurality of service providers, and (ii) a requester device of a requester to receive a transport request, the transport request specifying at least one of a service start location or service end location;
determining, from the current location of each service provider during a given time interval, a quantitative measure of service providers that are available in a given area to provide transport services;
determining, for the given area and a given time interval, a default parametric value that is based at least in part on the quantitative measure of service providers;
enabling each service provider of the plurality of service providers to select a parametric value of multiple possible parametric values for the given area, wherein the multiple possible parametric values include the default parametric value;
arranging transport to fulfill a transport request communicated from the requester device of the requester, including matching a service provider of the plurality of service providers to the transport request, based on a determination that the matched service provider satisfies each of (i) an arrival condition for the transport request of the requester, the arrival condition being based, at least in part, on a current location of the matched service provider and at least one of the service start location or the service end location; and (ii) a service value condition that is indicative of a service value that can be computed for the matched service provider to fulfill the transport request of the requester; and
in connection with the one or more processors arranging transport to fulfill the transport request, computing the service value based on the default parametric value, the service start location, and the service end location.

20. A method for operating a network computing system to arrange transport services, the method being implemented by one or more processors and comprising:
communicating, over one or more networks, with (i) a plurality of service provider devices to determine a current location of each service provider device of a plurality of service providers, and (ii) a requester device of a requester to receive a transport request, the transport request specifying at least one of a service start location or service end location;
determining, from the current location of each service provider during a given time interval, a quantitative measure of service providers that are available in a given area to provide transport services;
determining, for the given area and a given time interval, a default parametric value that is based at least in part on the quantitative measure of service providers;
enabling each service provider of the plurality of service providers to select a parametric value of multiple possible parametric values for the given area, wherein the multiple possible parametric values include the default parametric value;
arranging transport to fulfill a transport request communicated from the requester device of the requester, including matching a service provider of the plurality of service providers to the transport request, based on a determination that the matched service provider satisfies each of (i) an arrival condition for the transport request of the requester, the arrival condition being based, at least in part, on a current location of the matched service provider and at least one of the service start location or the service end location; and (ii) a service value condition that is indicative of a service value that can be computed for the matched service provider to fulfill the transport request of the requester; and
in connection with the one or more processors arranging transport to fulfill the transport request, computing the service value based on the default parametric value, the service start location, and the service end location.
